(19) United States
(12) Patent Application Publication
(10) Pub. No.: US 2025/0371635 A1
(43) Pub. Date: Dec. 4, 2025

(54) THINKING ABILITY PREDICTION METHOD AND APPARATUS BASED ON DEEP LEARNING, DEVICE AND COMPUTER-READABLE STORAGE MEDIUM

(71) Applicant: Central China Normal University, Wuhan (CN)

(72) Inventors: Xiuling HE, Wuhan (CN); Yangyang Li, Wuhan (CN); Xiong Xiao, Wuhan (CN); Jing Fang, Wuhan (CN); Yue Li, Wuhan (CN); Ruijie Zhou, Wuhan (CN)

(21) Appl. No.: 19/220,140

(22) Filed: May 28, 2025

(30) Foreign Application Priority Data
May 28, 2024 (CN) 202410668703.5

(51) Int. Cl. G06Q 50/20

(52) U.S. Cl. CPC G06Q 50/20

(57) ABSTRACT

A deep learning-based method for predicting thinking ability includes: obtaining a practice text set already completed by a user; inputting the exercise text set into an exercise classification model to obtain corresponding exercise categories for each exercise text in the exercise text set; mapping an exercise result set corresponding to the exercise text set to the exercise categories corresponding to each exercise text in the exercise text set, so as to obtain a correspondence set between the exercise categories and the exercise results; constructing an input vector based on the correspondence set between the exercise categories and the exercise results; and inputting the input vector into a thinking ability prediction model to obtain the user's thinking ability prediction result. A thinking ability prediction apparatus, device, and non-transitory computer-readable storage medium based on deep learning are also provided.

### CROSS-REFERENCE TO RELATED APPLICATIONS

The present application claims priority of Chinese Patent Application No. 202410668703.5, filed on May 28, 2024, the entire contents of which are hereby incorporated by reference.

### TECHNICAL FIELD

The present disclosure relates to the technical field of educational informatization technology, and specifically, to a thinking ability prediction method and apparatus based on deep learning, device and computer-readable storage medium.

### BACKGROUND

In current teaching practices, learners are assessed for their thinking ability, which helps them improve their cognition of their own thinking level and promote the development of learner's higher-order thinking skills.

Existing methods for assessing learners' thinking ability primarily include interview-based evaluation and activity-based evaluation. However, both interview-based and activity-based assessments require experienced experts to design specific interviews or activities, and are susceptible to factors such as evaluation criteria, expert biases, and topic variations. Therefore, there is an urgent need for an objective, accurate, and convenient method to predict learners' thinking ability.

### SUMMARY

The present disclosure provides a thinking ability prediction method and apparatus based on deep learning, electronic device and computer-readable storage medium, achieving objective, accurate, and convenient predictions of learners' thinking ability.

On the one hand, the present disclosure provides a deep learning-based method for predicting thinking ability, including:

obtaining an exercise text set already completed by a user;

inputting the exercise text set into an exercise classification model to obtain corresponding exercise categories for each exercise text in the exercise text set, wherein the exercise classification model comprises a pre-trained text classification model, a dropout layer, a fully connected layer, and a nonlinear activation layer;

mapping an exercise result set corresponding to the exercise text set to the exercise categories corresponding to each exercise text in the exercise text set, so as to obtain a correspondence set between the exercise categories and the exercise results;

constructing an input vector based on the correspondence set between the exercise categories and the exercise results; and

inputting the input vector into a thinking ability prediction model to obtain the user's thinking ability prediction result, wherein the thinking ability prediction model comprises a fully connected layer, a large language model, a dropout layer, a fully connected layer, and a nonlinear activation layer

Optionally, the large language model is one of GPT2, T5, or Llama; before inputting the input vector into the thinking ability prediction model, the method further includes:

training the large language model in a manner that self-attention blocks of the large language model is frozen.

Optionally, before inputting the exercise text set into the exercise classification model, the method further includes:

fine-tuning the exercise classification model using training data and a loss function, the loss function being a Focal loss.

Optionally, constructing an input vector based on the correspondence set between the exercise categories and the exercise results includes:

selecting T correspondences from the correspondence set between the exercise categories and the exercise results to construct multiple first vectors of length T, T being a positive integer;

obtaining answering times and subject study times for each exercise questions from the T correspondences; and

adding the answering times and study times respectively to the first vectors to obtain the input vector.

Optionally, before mapping an exercise result set corresponding to the exercise text set to the exercise categories corresponding to each exercise text in the exercise text set, the method further includes:

obtaining a similar exercise text subset from the exercise text set, where the similarity between exercise texts in the similar exercise text subset meets a similarity condition;

obtaining a similar exercise result subset corresponding to the similar exercise text subset from the exercise result set corresponding to the exercise text set;

when values in the similar exercise results subset are different, obtaining a correct answer rate or an incorrect answer rate of exercise knowledge points corresponding to the similar exercise text subset;

when the correct answer rate exceeds a first accuracy threshold, removing results marked as incorrect in the exercise result set corresponding to the similar exercise result subset;

when the incorrect answer rate exceeds a first error threshold, removing results marked as correct in the exercise result set corresponding to the similar exercise result subset;

when the correct answer rate is less than the first accuracy threshold and the incorrect answer rate is less than the first error threshold, calculating deviations between exercise performance characteristic values for each similar exercise text of the similar exercise text subset during the corresponding practice time periods and an average exercise performance value; and

when the deviation exceeds a positive deviation threshold, removing results marked as correct in the exercise result set corresponding to the similar exercise result subset.

Optionally, after obtaining an exercise text set already completed by a user, the method further includes:

obtaining text data exercised by the user within a preset time period and the user's age;

calculating the total volume of the obtained text data; and

deleting or retaining the obtained text data based on the total volume and the user's age, and further determining the retained text date to form the exercise text set.

Optionally, deleting or retaining the obtained text data based on the total volume and the user's age, and further determining the retained text date to form the exercise text set comprises:

calculating a first data volume of a text data originating from in-class sources of the total data volume and a second data volume of a text data originating from out-of-class sources of the total data volume based on a text source of the text data; and

deleting or retaining the obtained text data based on the first data volume, the second data volume, and the user's age, and further determining the retained text date to form the exercise text set.

The present disclosure also provides a deep learning-based apparatus for predicting thinking ability including:

an obtaining module configured for obtaining an exercise text set already completed by a user;

a first prediction module configured for inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer;

a mapping module configured for mapping an exercise result set corresponding to the exercise text set to the exercise categories corresponding to each exercise text in the exercise text set, so as to obtain a correspondence set between the exercise categories and the exercise results;

a vector construction module configured for constructing an input vector based on the correspondence set between the exercise categories and the exercise results; and

a second prediction module configured for inputting the input vector into a thinking ability prediction model to obtain the user's thinking ability prediction result, wherein the thinking ability prediction model includes a fully connected layer, a large language model, a dropout layer, a fully connected layer, and a nonlinear activation layer.

Optionally, the large language model is one of GPT2, T5, or Llama; the apparatus further comprises second model adjustment module is configured for:

training the large language model in a manner that self-attention blocks of the large language model is frozen before inputting the input vector into the thinking ability prediction model

Optionally, the apparatus further includes a first model adjustment module configured for:

fine-tuning the exercise classification model using training data and a loss function before inputting the exercise text set into the exercise classification model, wherein the loss function is a Focal loss.

Optionally, the vector construction module is specifically configured for:

selecting T correspondences from the correspondence set between the exercise categories and the exercise results to construct multiple first vectors of length T, where T is a positive integer;

obtaining answering times and subject study times for each exercise questions from the T correspondences;

adding the answering times and study times respectively to the first vectors to obtain the input vector.

Optionally, the apparatus further includes a second adjustment module configured for:

before mapping an exercise result set corresponding to the exercise text set to the exercise categories corresponding to each exercise text in the exercise text set, obtaining a similar exercise text subset from the exercise text set, where the similarity between exercise texts in the similar exercise text subset meets a similarity condition;

obtaining a similar exercise result subset corresponding to the similar exercise text subset from the exercise result set corresponding to the exercise text set;

when values in the similar exercise results subset are different, obtaining a correct answer rate or an incorrect answer rate of exercise knowledge points corresponding to the similar exercise text subset;

when the correct answer rate exceeds a first accuracy threshold, removing results marked as incorrect in the exercise result set corresponding to the similar exercise result subset;

when the incorrect answer rate exceeds a first error threshold, removing results marked as correct in the exercise result set corresponding to the similar exercise result subset;

when the correct answer rate is less than the first accuracy threshold and the incorrect answer rate is less than the first error threshold, calculating deviations between exercise performance characteristic values for each similar exercise text of the similar exercise text subset during the corresponding practice time periods and an average exercise performance value; and

when the deviation exceeds a positive deviation threshold, removing results marked as correct in the exercise result set corresponding to the similar exercise result subset.

Optionally, the apparatus further includes a first adjustment module configured for:

obtaining text data exercised by the user within a preset time period and the user's age after obtaining the exercise text set already completed by the user;

calculating the total volume of the obtained text data;

deleting or retaining the obtained text data based on the total volume and the user's age, and further determining the retained text date to form the exercise text set.

Optionally, the first adjustment module is further configured for:

calculating a first data volume of a text data originating from in-class sources of the total data volume and a second data volume of a text data originating from out-of-class sources of the total data volume based on a text source of the text data; and

deleting or retaining the obtained text data based on the first data volume, the second data volume, and the user's age, and further determining the retained text date to form the exercise text set.

The present disclosure further provides a electronic device including:

a storage device, storing executable program code;

a processor, coupled to the storage device, wherein the processor calls the executable program code stored in the storage device to execute the deep learning-based method for predicting thinking ability described above.

The present disclosure further provides a computer-readable storage medium storing a non-transitory computer program, wherein when the computer program is executed by a processor, it implements the deep learning-based method for predicting thinking ability described above.

In the present embodiment, the following method is provided: obtaining an exercise text set already completed by a user; inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer; mapping an exercise result set corresponding to the exercise text set to the exercise categories corresponding to each exercise text in the exercise text set, so as to obtain a correspondence set between the exercise categories and the exercise results; constructing an input vector based on the correspondence set between the exercise categories and the exercise results; and inputting the input vector into a thinking ability prediction model to obtain the user's thinking ability prediction result, wherein the thinking ability prediction model includes a fully connected layer, a large language model, a dropout layer, a fully connected layer, and a nonlinear activation layer. The embodiment of the present disclosure does not require evaluation by an expert supervisor, nor do they need to specifically design a particular interview or activity, and the user's thinking ability prediction results can be quickly obtained based on the exercises that the user has participated in, and the evaluation efficiency is highly effective. The purpose of objectively, accurately and conveniently predicting the thinking ability of the learner is realized.

### BRIEF DESCRIPTION OF DRAWINGS

To more clearly illustrate the technical solutions in the embodiments of the present disclosure or prior art, the accompanying drawings to be used in the description of the embodiments or prior art will be briefly introduced below, and it will be obvious that the accompanying drawings in the following description are some of the embodiments of the present disclosure, and that for a person of ordinary skill in the field, other accompanying drawings can be obtained based on these drawings without paying for creative laboriousness.

FIG. 1 is a flowchart of a thinking ability prediction method based on deep learning provided in an embodiment of the present disclosure;

FIG. 2 is a schematic diagram of a structure of a thinking ability prediction apparatus based on deep learning provided in an embodiment of the present disclosure;

FIG. 3 is a schematic diagram of a hardware structure of an electronic device provided in an embodiment of the present disclosure.

### DESCRIPTION OF EMBODIMENTS

In order to make the objects, technical solutions and advantages of the embodiments of the present disclosure clearer, the technical solutions in the embodiments of the present disclosure will be described clearly and completely in the following in conjunction with the accompanying drawings in the embodiments of the present disclosure. It is clear that the described embodiments are a part of, other than all of the embodiments of the present disclosure. Based on the embodiments of the present disclosure, all other embodiments obtained by ordinary technicians in the field without making any creative work shall fall within the protection scope of the present disclosure.

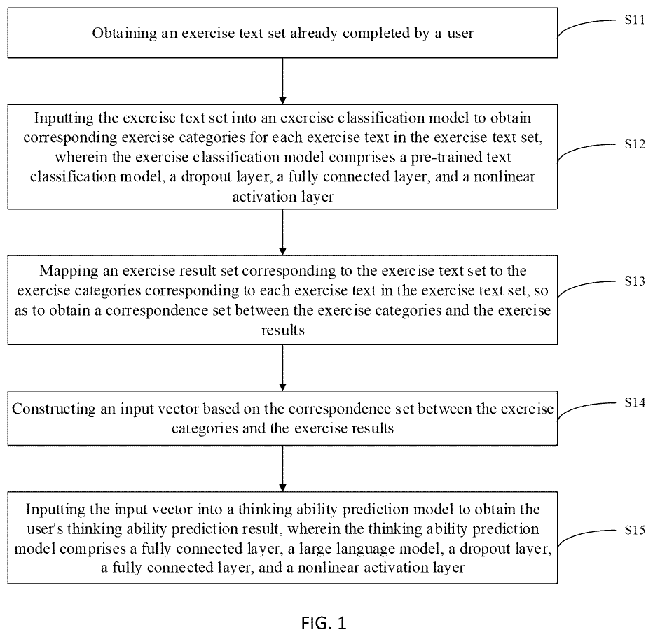

Referring to FIG. 1, a flowchart illustrating a deep learning-based method for predicting thinking ability according to an embodiment of the present disclosure is shown. This method can be applied to electronic devices such as personal computers or servers. As shown in FIG. 1, the method specifically includes:

Step S11: Obtaining an exercise text set already completed by a user.

In this embodiment, the user is a learner, such as a middle school student, high school student, or college student.

In this embodiment, exercise refers to completing questions interactively by the user during the learning process. The exercise text set includes the textual content involved in these exercises, such as the text of multiple-choice questions, the text of true/false questions.

Specifically, the exercise text set may include several exercise texts from one or multiple subjects.

Optionally, the exercise text set may be obtained from one user or multiple users.

Specifically, if the exercise is conducted online, the exercise text can be obtained via network transmission. If the exercise is conducted offline, the exercise text can be obtained by scanning images of the practice and then recognizing the texts through image recognition technology.

Further, in an optional embodiment of the present disclosure, after obtaining an exercise text set already completed by a user, the method further includes:

obtaining text data exercised by the user within a preset time period and the user's age;

calculating the total volume of the obtained text data;

deleting or retaining the obtained text data based on the total volume and the user's age, and further determining the retained text date to form the exercise text set.

In this embodiment, the preset time period can be a preset value. For example, the preset time period can be three months, one semester, or one year.

In this embodiment, the user's age can be obtained in various ways.

In one optional embodiment, the user's age can be obtained from input age data.

In another optional embodiment, the user's age can be obtained through analyzing the text data.

In yet another optional embodiment, the user's age can be obtained from a user information database. The user information database contains a correspondence between user identity identifiers and user names and ages; the user's age can be obtained based on the user ID or age.

In this embodiment, the total volume of the obtained text data refers to the total volume of text data that the user has participated in exercising during the preset time period.

In this embodiment, after deleting or retaining each of the text data, the remaining text data that are not deleted form the exercise text set.

In this embodiment, deleting or retaining the obtained text data based on the total volume and the user's age includes:

when the total volume is less than a first preset volume and the user's age is less than a first preset age, retaining all obtained text data;

when the total volume exceeds a second preset volume and the user's age exceeds a second preset age, deleting some obtained text data and retaining the rest.

The values of the first preset volume and the second preset volume can be the same or different. Specifically, the second preset volume is greater than or equal to the first preset volume. For example, both the first preset volume and the second preset volume can be 10,000.

The values of the first preset age and the second preset age can be the same or different. Specifically, the second preset age is greater than or equal to the first preset age. For example, the first preset age can be 8 years old, and the second preset age can be 18 years old.

In this embodiment, when the total volume is less than the first preset volume, it indicates that the total volume has not reached the first preset volume and may be relatively small. Additionally, if the user's age is less than the first preset age, it suggests that the user is relatively young, and the reliability of the obtained text data may be higher. Therefore, retaining all obtained text data can maintain data richness and improve the accuracy and reliability of the prediction.

In this embodiment, when the total volume exceeds the second preset volume, it indicates that the total volume has reached the second preset volume and may be relatively large. Furthermore, if the user's age exceeds the second preset age, it suggests that the user is relatively old. The possibility of unreliable data in the obtained text data increases. In this case, deleting some obtained text data and retaining the rest can not only maintain data richness but also enhance the accuracy, efficiency, and reliability of the prediction. Specifically, the amount of text data to be deleted can be determined based on the difference between the total volume and the first preset volume to ensure that the volume of retained text data is no less than the first preset volume after deletion. For example, if the total volume is 20,000, then 5,000 text data can be deleted, leaving 15,000 retained text data. Alternatively, abnormal value detection or variance calculation methods can be used to delete some text data from the obtained text data, resulting in the retained text data.

Further, in an optional embodiment of the present disclosure, deleting or retaining the obtained text data based on the total volume and the user's age, and further determining the retained text date to form the exercise text set includes:

calculating a first data volume of a text data originating from in-class sources of the total data volume and a second data volume of a text data originating from out-of-class sources of the total data volume based on a text source of the text data;

deleting or retaining the obtained text data based on the first data volume, the second data volume, and the user's age, and further determining the retained text date to form the exercise text set.

In this embodiment, the text source of the text data can be obtained from pre-set labels in the text data. For example, the text data may contain labels indicating the text source, such as in-class source labels and out-of-class source labels.

In this embodiment, the text data belonging to in-class sources refers to text data originating from classroom exercise or exercise conducted under the supervision of a teacher. The text data belonging to out-of-class sources refers to text data originating from non-classroom exercise.

For example, if the total volume is 10,000, the first data volume is 3,000, and the second data volume is 7,000.

In one optional embodiment, the first data volume and the second data volume can be determined by the following formulas:

$${P}_{1} = \frac{f ( D , A )}{f ( D , A ) + g ( D , A )} \times D$$

$${P}_{2} = \frac{g ( D , A )}{f ( D , A ) + g ( D , A )} \times D$$

where “P1” is the first data volume; “P2” is the second data volume; “D” is the total volume of obtained text data; “A” represents the user's age, which can be encoded with different values for different age groups, such as “1” for primary school students, “2” for middle school students, and “3” for college students; f(D, A) and g(D, A) are functions related to the total volume and the user's age, the specific expressions of which can vary with changes in the total volume and the user's age.

For instance, f(D, A) can be a linear function of the total volume “D” and the user's age “A”, indicating that as the total volume increases and the user's age increases, the proportion of in-class practice data selected increases. Meanwhile, g(D, A) can be an exponential function, indicating that as the data volume increases and the user's age increases, the proportion of out-of-class practice data selected also increases.

Step S12: Inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer.

In this embodiment, the exercise classification model is used to identify the exercise category corresponding to each exercise text.

Specifically, the exercise categories include five types: memory, comprehension, application, analysis, and synthesis/creation. The exercise classification model makes it possible to determine which exercise category corresponds to each exercise text.

For example, exercise text A “What is the definition of file redirection in C language?” corresponds to a exercise category of “memory”, marked as “Level_1”. Practice text B “Correct the errors in the program (code): The program is designed to enter student ID and score from the keyboard, and when entered number is 0, it indicates the end of creating the chain table and prints out the student IDs and scores entered.” This exercise text not only tests the understanding of basic knowledge such as chain table and memory allocation, but also requires analysis and reflection during the answering process, thus corresponding to exercise category of “analysis”, marked as “Level_4”.

In an optional embodiment of the present disclosure, the pre-trained text classification model is a pre-trained BERT model. Specifically, in this embodiment, the BERT is obtained after pre-training and then fine-tuning, and the pre-trained BERT model is a model that has been obtained by using a bidirectional Transformer network that has been trained on a large corpus.

In this embodiment, in order to make the rich linguistic knowledge and semantic representation learned in the pre-training of the text classification model (e.g., BERT) used for practicing the categories of the text, a dropout layer, a fully connected layer, and a nonlinear activation layer are added after the outputs of the text classification model (e.g., BERT) to construct the exercise classification model.

Specifically, the dropout layer can alleviate overfitting that occurs during fine-tuning retraining. The fully connected layer maps the feature space obtained from the previous layer to the sample labeling space to improve robustness. The nonlinear activation layer text can use the ReLU activation function, which serves to introduce nonlinear transformations and control the value of the output, thereby improving the model's generalization ability.

Further, in an optional embodiment of the present disclosure, before inputting the exercise text set into the exercise classification model, the method further includes:

fine-tuning the exercise classification model using training data and a loss function, wherein the loss function is a Focal loss.

In this embodiment, the training data includes training input data and training output data. The training input data is the training exercise text, and the training output data is the labeled exercise category output text. The fine-tuning process of the exercise classification model is a supervised learning approach.

In this embodiment, since learners tend to interact more with memory-type, comprehension-type, and application-type exercises in the early stages of learning, it is only when the learners are proficient in the basic concepts that they will try to analyze the analysis-type and synthesis/creation-type exercises. As a result, there may be data imbalance in the training data, which leads to phenomena such as overfitting or underfitting of the model. Therefore, Focal loss is used as the loss function, Focal loss is a dynamically scaled cross-entropy loss, through a dynamic scaling factor, can dynamically reduce the weight of the easily distinguishable samples in the training process, so as to focus the center of gravity quickly on those samples that are difficult to distinguish, and thus alleviate the phenomena such as overfitting or underfitting of the model caused by data imbalance.

Step S13: Mapping an exercise result set corresponding to the exercise text set to the exercise categories corresponding to each exercise text in the exercise text set, so as to obtain a correspondence set between the exercise categories and the exercise results.

In this embodiment, the exercise result set includes exercise results (such as correct or incorrect) and identifications of the exercise questions (such as exercise IDs). For example, exercise results can be represented as {q, r}, where “q” denotes the sequence of IDs for the practices undertaken by the user; and r^{∈}{0, 1} indicates the exercise result, where “0” denotes an incorrect answer and “1” denotes a correct answer. After mapping, the correspondences are {s, r}, where “r” is the exercise result and “s” is the exercise category. In other words, the mapping results in the exercise category corresponding to each exercise result. For example, the mapping yields a set of correspondences between the exercise results of one hundred exercise questions and the exercise categories of those one hundred exercise questions.

Further, in an optional embodiment of the present disclosure, before mapping an exercise result set corresponding to the exercise text set to the exercise categories corresponding to each exercise text in the exercise text set, the method further includes:

obtaining a similar exercise text subset from the exercise text set, where the similarity between exercise texts in the similar exercise text subset meets a similarity condition;

obtaining a similar exercise result subset corresponding to the similar exercise text subset from the exercise result set corresponding to the exercise text set;

if values in the similar exercise results subset are different, obtaining the correct answer rate or incorrect answer rate of the exercise knowledge points corresponding to the similar exercise text subset;

if the correct answer rate exceeds a first accuracy threshold, removing results marked as incorrect in the exercise result set corresponding to the similar exercise result subset;

if the incorrect answer rate exceeds a first error threshold, removing results marked as correct in the exercise result set corresponding to the similar exercise result subset;

if the correct answer rate is less than the first accuracy threshold and the incorrect answer rate is less than the first error threshold, calculating deviations between exercise performance characteristic values for each similar exercise text of the similar exercise text subset during the corresponding practice time periods and an average exercise performance value;

if the deviation exceeds a positive deviation threshold, removing results marked as correct in the exercise result set corresponding to the similar exercise result subset.

In this embodiment, the number of similar exercise text subset can be at least two. The similarity between exercise texts in the subset meets a similarity condition, i.e., the similarity between exercise texts is greater than a first similarity threshold (e.g., 90%).

In this embodiment, the corresponding exercise knowledge point of the similar exercise text subset can be obtained through text analysis or from a correspondence in a database.

In this embodiment, the first accuracy threshold and the first error threshold can be preset values. For example, the first accuracy threshold and the first error threshold can both be 90%.

In this embodiment, the exercise performance characteristic value refers to the exercise performance characteristic value during the corresponding practice time period. The average exercise performance value is the average of the exercise performance characteristic values for a plurality of practice time periods including the practice time period. Specifically, the exercise performance characteristic value may be obtained by a combined calculation based on factors such as the total results of the practice and the practice time.

In this embodiment, the preset positive deviation threshold can be a preset value, such as 0.3. For example, the exercise performance characteristic value during a practice time period is 0.9 and the average exercise performance is 0.5, the deviation is 0.4, which exceeds the preset positive deviation threshold of 0.3. In this case, results marked as correct in the exercise result set corresponding to the similar exercise result subset are deleted.

Further, if the deviation between exercise performance characteristic value for each similar exercise text of the similar exercise text subset during the corresponding practice time periods and the average exercise performance value is less than a negative deviation threshold, removing results marked as incorrect in the exercise result set corresponding to the similar exercise result subset. For instance, if the exercise performance characteristic value during a practice time period is 0.1 and the average exercise performance is 0.5, the deviation is −0.4, which is less than the preset negative deviation threshold of −0.3. In this case, results marked as incorrect in the exercise result set corresponding to the similar exercise result subset are deleted.

For example, get similar exercise text subsets {W₊, W₋} and {Y₊, Y₋}, and then get the results of exercise text W₊ and exercise text W₋ respectively, i.e., the similar exercise result subset: {0, 1}. When the results corresponding to similar exercise text are different, then obtain the correct or incorrect answer rate of the exercise knowledge points corresponding to the similar exercise text subset {W₊, W₋}. If the correct answer rate is 95%, which is greater than the first correct rate of 90%, the result with answer “0” is deleted, i.e., the results corresponding to the question with answer “0” are deleted from the exercise result set. If the error answer rate is 91%, which is greater than the first incorrect answer rate 90%, results with answer “1” are deleted, i.e., results corresponding to the question with answer “1” are deleted from the exercise result set. If the correct answer rate is 55%, which is less than the first correct rate of 90% and less than the first incorrect answer rate of 90%, the deviation of the exercise performance characteristic values of the practice time period (i.e., the answer time period) corresponding to W+and W-from the average exercise performance value of all the practice time periods of the user is calculated separately, and if this deviation is greater than the positive deviation threshold, the results with answer “1” are deleted, and if this deviation is less than the negative deviation threshold, the result with answer “0” are deleted.

In this embodiment, after the result is deleted, the exercise category corresponding to the result is no longer obtained when mapping is performed, i.e., the exercise category corresponding to the result is not used for subsequent operations, which reduces unreliable values and deletes values that cannot accurately reflect the user's learning in a similar topic, thereby improving the reliability and accuracy of the prediction results.

Step S14: Constructing an input vector based on the correspondence set between the exercise categories and the exercise results.

In this embodiment, multiple input vectors can be constructed by selecting several data from the correspondence set.

Specifically, multiple input vectors X={x₁, x₂, x₃, x₄, x₅, . . . , X_{T}} of length T can be constructed by selecting T data multiple times from the correspondence set, where x_{T}={s_{T}, r_{T}}, i.e., x_{T} includes the exercise category s_{T} for the Tth exercise question and exercise result r_{T} for the Tth exercise question.

For instance, the input vector is constructed based on the maximum input length T of the model (i.e., the thinking ability prediction model). If the length of the correspondence set obtained from a single practice session is less than T, it is considered that the user has insufficient practice, and such records are discarded. If the length of the correspondence set exceeds T, it is truncated into multiple input vectors of length T.

Further, in an optional embodiment of the present disclosure, constructing an input vector based on the correspondence set between the exercise categories and the exercise results includes:

selecting T correspondences from the correspondence set between the exercise categories and the exercise results to construct multiple first vectors of length T, where T is a positive integer;

obtaining answering times and subject study times for each exercise questions from the T correspondences;

adding the answering times and study times respectively to the first vectors to obtain the input vector.

In this embodiment, the subject study time refers to the study time of the subject to which the exercise question belongs. The resulting input vector is an enhanced representation vector.

For example, get T correspondences between the exercise results and the exercise categories of T exercise questions. Then obtain the answer times of the T exercise questions and the study time of the subject to which each exercise question belongs in these T correspondences, and add them to the first vector to obtain the input vector as X={x₁, x₂, x₃, x₄, x₅, . . . , x_{T}}, where x_{T}={s_{T}, r_{T}, m_{T}, n_{T}}, i.e., XT, which includes the exercise category s_{T} for the Tth exercise question, the exercise result r_{T} for the Tth exercise question, the answer time m_{T} for the Tth exercise question, the study time for the Tth exercise question, the study time n_{T} for the subject to which each exercise question belongs.

In this embodiment, by adding answering times and study times to the first vectors, the input vector not only includes practice types and results but also incorporates answering times and study times, allowing for a more accurate prediction of the student's thinking ability.

Step S15: Inputting the input vector into a thinking ability prediction model to obtain the user's thinking ability prediction result, wherein the thinking ability prediction model includes a fully connected layer, a large language model, a dropout layer, a fully connected layer, and a nonlinear activation layer.

In this embodiment, the obtained thinking ability prediction result is a coefficient of each thinking ability corresponding to the user (including memory, comprehension, application, analysis, and synthesis/creation), e.g., the result of thinking ability is {0.8, 0.8, 0.7, 0.6, 0.5}.

Further, in an optional embodiment of the present disclosure, the large language model can be one of GPT2, T5, or Llama. Before inputting the input vector into the thinking ability prediction model, the method further includes:

training the large language model in a manner that self-attention blocks of the large language model is frozen.

For example, in the GPT-2 model, the self-attention blocks are located in the first layer of each Transformer block. Thus, the first layer of each Transformer block is frozen during training.

In this embodiment, since the self-attention blocks contain most of the knowledge learned during pre-training, freezing them during fine-tuning protects the performance of the large language model. Meanwhile, the position embeddings and layer normalizations in the large language model are primarily used to enhance downstream tasks. Therefore, these components are retrained to adapt to the thinking ability prediction task.

Further, in an optional embodiment of the present disclosure, the loss function is the cross-entropy loss function.

This training approach of the present embodiment improves training efficiency while ensuring the accuracy of the model obtained from training.

In the present embodiment, the following method is provided: obtaining an exercise text set already completed by a user; inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer; mapping an exercise result set corresponding to the exercise text set to the exercise categories corresponding to each exercise text in the exercise text set, so as to obtain a correspondence set between the exercise categories and the exercise results; constructing an input vector based on the correspondence set between the exercise categories and the exercise results; and inputting the input vector into a thinking ability prediction model to obtain the user's thinking ability prediction result, wherein the thinking ability prediction model includes a fully connected layer, a large language model, a dropout layer, a fully connected layer, and a nonlinear activation layer. The embodiment of the present disclosure does not require evaluation by an expert supervisor, nor do they need to specifically design a particular interview or activity, and the user's thinking ability prediction results can be quickly obtained based on the exercises that the user has participated in, and the evaluation efficiency is highly effective. The purpose of objectively, accurately and conveniently predicting the thinking ability of the learner is realized.

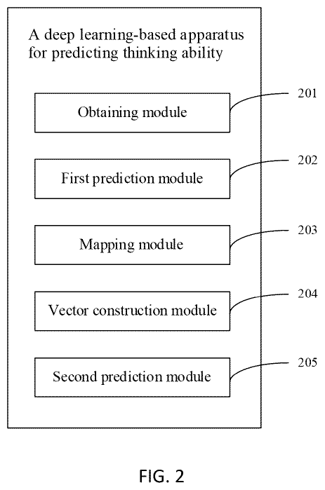

Referring to FIG. 2, a structural schematic diagram of a deep learning-based apparatus for predicting thinking ability according to an embodiment of the present disclosure is shown. To facilitate description, only parts relevant to the present disclosure are shown. The apparatus can be deployed in electronic devices such as personal computers or servers. The deep learning-based apparatus for predicting thinking includes:

An obtaining module 201 for obtaining an exercise text set already completed by a user.

In this embodiment, the user is a learner, such as a middle school student, high school student, or college student.

In this embodiment, exercise refers to completing questions interactively by the user during the learning process. The exercise text set includes the textual content involved in these exercises, such as the text of multiple-choice questions, the text of true/false questions.

Specifically, the exercise text set may include several exercise texts from one or multiple subjects.

Optionally, the exercise text set may be obtained from one user or multiple users.

Specifically, if the practice is conducted online, the exercise text can be obtained via network transmission. If the practice is conducted offline, the exercise text can be obtained by scanning images of the practice and then recognizing the texts through image recognition technology.

Further, in an optional embodiment of the present disclosure, the apparatus further includes: a first adjustment module is used for:

obtaining text data exercised by the user within a preset time period and the user's age after obtaining the exercise text set already completed by the user;

calculating the total volume of the obtained text data;

deleting or retaining the obtained text data based on the total volume and the user's age, and further determining the retained text date to form the exercise text set.

In this embodiment, the preset time period can be a preset value. For example, the preset time period can be three months, one semester, or one year.

In this embodiment, the user's age can be obtained in various ways.

In one optional embodiment, the user's age can be obtained from input age data.

In another optional embodiment, the user's age can be obtained through analyzing the text data.

In yet another optional embodiment, the user's age can be obtained from a user information database. The user information database contains a correspondence between user identity identifiers and user names and ages; the user's age can be obtained based on the user ID or age.

In this embodiment, the total volume of the obtained text data refers to the total volume of text data that the user has participated in exercising during the preset time period.

In this embodiment, after deleting or retaining each of the text data, the remaining text data that are not deleted form the exercise text set.

In this embodiment, deleting or retaining the obtained text data based on the total volume and the user's age includes:

when the total volume is less than a first preset volume and the user's age is less than a first preset age, retaining all obtained text data;

when the total volume exceeds a second preset volume and the user's age exceeds a second preset age, deleting some obtained text data and retaining the rest.

The values of the first preset volume and the second preset volume can be the same or different. Specifically, the second preset volume is greater than or equal to the first preset volume. For example, both the first preset volume and the second preset volume can be 10,000.

The values of the first preset age and the second preset age can be the same or different. Specifically, the second preset age is greater than or equal to the first preset age. For example, the first preset age can be 8 years old, and the second preset age can be 18 years old.

In this embodiment, when the total volume is less than the first preset volume, it indicates that the total volume has not reached the first preset volume and may be relatively small. Additionally, if the user's age is less than the first preset age, it suggests that the user is relatively young, and the reliability of the obtained text data may be higher. Therefore, retaining all obtained text data can maintain data richness and improve the accuracy and reliability of the prediction.

In this embodiment, when the total volume exceeds the second preset volume, it indicates that the total volume has reached the second preset volume and may be relatively large. Furthermore, if the user's age exceeds the second preset age, it suggests that the user is relatively old. The possibility of unreliable data in the obtained text data increases. In this case, deleting some obtained text data and retaining the rest can not only maintain data richness but also enhance the accuracy, efficiency, and reliability of the prediction. Specifically, the amount of text data to be deleted can be determined based on the difference between the total volume and the first preset volume to ensure that the volume of retained text data is no less than the first preset volume after deletion. For example, if the total volume is 20,000, then 5,000 text data can be deleted, leaving 15,000 retained text data. Alternatively, abnormal value detection or variance calculation methods can be used to delete some text data from the obtained text data, resulting in the retained text data.

Further, in an optional embodiment of the present disclosure, deleting or retaining the obtained text data based on the total volume and the user's age, and further determining the retained text date to form the exercise text set includes:

calculating a first data volume of a text data originating from in-class sources of the total data volume and a second data volume of a text data originating from out-of-class sources of the total data volume based on a text source of the text data;

deleting or retaining the obtained text data based on the first data volume, the second data volume, and the user's age, and further determining the retained text date to form the exercise text set.

In this embodiment, the text source of the text data can be obtained from pre-set labels in the text data. For example, the text data may contain labels indicating the text source, such as in-class source labels and out-of-class source labels.

In this embodiment, the text data belonging to in-class sources refers to text data originating from classroom exercise or exercise conducted under the supervision of a teacher. The text data belonging to out-of-class sources refers to text data originating from non-classroom exercise.

For example, if the total volume is 10,000, the first data volume is 3,000, and the second data volume is 7,000.

In one optional embodiment, the first data volume and the second data volume can be determined by the following formulas:

$${P}_{1} = \frac{f ( D , A )}{f ( D , A ) + g ( D , A )} \times D$$

$${P}_{2} = \frac{g ( D , A )}{f ( D , A ) + g ( D , A )} \times D$$

where “P1” is the first data volume; “P2” is the second data volume; “D” is the total volume of obtained text data; “A” represents the user's age, which can be encoded with different values for different age groups, such as “1” for primary school students, “2” for middle school students, and “3” for college students; f(D, A) and g(D, A) are functions related to the total volume and the user's age, the specific expressions of which can vary with changes in the total volume and the user's age.

For instance, f(D, A) can be a linear function of the total volume “D” and the user's age “A”, indicating that as the total volume increases and the user's age increases, the proportion of in-class practice data selected increases. Meanwhile, g(D, A) can be an exponential function, indicating that as the data volume increases and the user's age increases, the proportion of out-of-class practice data selected also increases.

A first prediction module 202 for inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer.

In this embodiment, the exercise classification model is used to identify the exercise category corresponding to each exercise text.

Specifically, the exercise categories include five types: memory, comprehension, application, analysis, and synthesis/creation. The exercise classification model makes it possible to determine which exercise category corresponds to each exercise text.

For example, exercise text A “What is the definition of file redirection in C language?” corresponds to a exercise category of “memory”, marked as “Level_1”. Practice text B “Correct the errors in the program (code): The program is designed to enter student ID and score from the keyboard, and when entered number is 0, it indicates the end of creating the chain table and prints out the student IDs and scores entered.” This exercise text not only tests the understanding of basic knowledge such as chain table and memory allocation, but also requires analysis and reflection during the answering process, thus corresponding to exercise category of “analysis”, marked as “Level_4”.

In an optional embodiment of the present disclosure, the pre-trained text classification model is a pre-trained BERT model. Specifically, in this embodiment, the BERT is obtained after pre-training and then fine-tuning, and the pre-trained BERT model is a model that has been obtained by using a bidirectional Transformer network that has been trained on a large corpus.

In this embodiment, in order to make the rich linguistic knowledge and semantic representation learned in the pre-training of the text classification model (e.g., BERT) used for practicing the categories of the text, a dropout layer, a fully connected layer, and a nonlinear activation layer are added after the outputs of the text classification model (e.g., BERT) to construct the exercise classification model.

Specifically, the dropout layer can alleviate overfitting that occurs during fine-tuning retraining. The fully connected layer maps the feature space obtained from the previous layer to the sample labeling space to improve robustness. The nonlinear activation layer text can use the ReLU activation function, which serves to introduce nonlinear transformations and control the value of the output, thereby improving the model's generalization ability.

Further, in an optional embodiment of the present disclosure, the apparatus further includes a first model adjustment module. The first model adjustment module is used for:

fine-tuning the exercise classification model using training data and a loss function before inputting the exercise text set into the exercise classification model, wherein the loss function is a Focal loss.

In this embodiment, the training data includes training input data and training output data. The training input data is the training exercise text, and the training output data is the labeled exercise category output text. The fine-tuning process of the exercise classification model is a supervised learning approach.

In this embodiment, since learners tend to interact more with memory-type, comprehension-type, and application-type exercises in the early stages of learning, it is only when the learners are proficient in the basic concepts that they will try to analyze the analysis-type and synthesis/creation-type exercises. As a result, there may be data imbalance in the training data, which leads to phenomena such as overfitting or underfitting of the model. Therefore, Focal loss is used as the loss function, Focal loss is a dynamically scaled cross-entropy loss, through a dynamic scaling factor, can dynamically reduce the weight of the easily distinguishable samples in the training process, so as to focus the center of gravity quickly on those samples that are difficult to distinguish, and thus alleviate the phenomena such as overfitting or underfitting of the model caused by data imbalance.

A mapping module 203 used for mapping an exercise result set corresponding to the exercise text set to the exercise categories corresponding to each exercise text in the exercise text set, so as to obtain a correspondence set between the exercise categories and the exercise results.

In this embodiment, the exercise result set includes exercise results (such as correct or incorrect) and identifications of the exercise questions (such as exercise IDs). For example, exercise results can be represented as {q, r}, where “q” denotes the sequence of IDs for the practices undertaken by the user; and r^{∈}{0, 1} indicates the exercise result, where “0” denotes an incorrect answer and “1” denotes a correct answer. After mapping, the correspondences are {s, r}, where “r” is the exercise result and “s” is the exercise category. In other words, the mapping results in the exercise category corresponding to each exercise result. For example, the mapping yields a set of correspondences between the exercise results of one hundred exercise questions and the exercise categories of those one hundred exercise questions.

Further, in an optional embodiment of the present disclosure, the apparatus includes a second adjustment module. The second adjustment module is used for:

before mapping an exercise result set corresponding to the exercise text set to the exercise categories corresponding to each exercise text in the exercise text set, obtaining a similar exercise text subset from the exercise text set, where the similarity between exercise texts in the similar exercise text subset meets a similarity condition;

obtaining a similar exercise result subset corresponding to the similar exercise text subset from the exercise result set corresponding to the exercise text set;

if values in the similar exercise results subset are different, obtaining the correct answer rate or incorrect answer rate of the exercise knowledge points corresponding to the similar exercise text subset;

if the correct answer rate exceeds a first accuracy threshold, removing results marked as incorrect in the exercise result set corresponding to the similar exercise result subset;

if the incorrect answer rate exceeds a first error threshold, removing results marked as correct in the exercise result set corresponding to the similar exercise result subset;

if the correct answer rate is less than the first accuracy threshold and the incorrect answer rate is less than the first error threshold, calculating deviations between exercise performance characteristic values for each similar exercise text of the similar exercise text subset during the corresponding practice time periods and an average exercise performance value;

if the deviation exceeds a positive deviation threshold, removing results marked as correct in the exercise result set corresponding to the similar exercise result subset.

In this embodiment, the number of similar exercise text subset can be at least two. The similarity between exercise texts in the subset meets a similarity condition, i.e., the similarity between exercise texts is greater than a first similarity threshold (e.g., 90%).

In this embodiment, the corresponding exercise knowledge point of the similar exercise text subset can be obtained through text analysis or from a correspondence in a database.

In this embodiment, the first accuracy threshold and the first error threshold can be preset values. For example, the first accuracy threshold and the first error threshold can both be 90%.

In this embodiment, the exercise performance characteristic value refers to the exercise performance characteristic value during the corresponding practice time period. The average exercise performance value is the average of the exercise performance characteristic values for a plurality of practice time periods including the practice time period. Specifically, the exercise performance characteristic value may be obtained by a combined calculation based on factors such as the total results of the practice and the practice time.

In this embodiment, the preset positive deviation threshold can be a preset value, such as 0.3. For example, the exercise performance characteristic value during a practice time period is 0.9 and the average exercise performance is 0.5, the deviation is 0.4, which exceeds the preset positive deviation threshold of 0.3. In this case, results marked as correct in the exercise result set corresponding to the similar exercise result subset are deleted.

Further, if the deviation between exercise performance characteristic value for each similar exercise text of the similar exercise text subset during the corresponding practice time periods and the average exercise performance value is less than a negative deviation threshold, removing results marked as incorrect in the exercise result set corresponding to the similar exercise result subset. For instance, if the exercise performance characteristic value during a practice time period is 0.1 and the average exercise performance is 0.5, the deviation is −0.4, which is less than the preset negative deviation threshold of −0.3. In this case, results marked as incorrect in the exercise result set corresponding to the similar exercise result subset are deleted.

For example, get similar exercise text subsets {W₊, W₋} and {Y₊, Y₋}, and then get the results of exercise text W₊ and exercise text W₊ respectively, i.e., the similar exercise result subset: {0, 1}. When the results corresponding to similar exercise text are different, then obtain the correct or incorrect answer rate of the exercise knowledge points corresponding to the similar exercise text subset {W+, W−}. If the correct answer rate is 95%, which is greater than the first correct rate of 90%, the result with answer “0” is deleted, i.e., the results corresponding to the question with answer “0” are deleted from the exercise result set. If the error answer rate is 91%, which is greater than the first incorrect answer rate 90%, results with answer “1” are deleted, i.e., results corresponding to the question with answer “1” are deleted from the exercise result set. If the correct answer rate is 55%, which is less than the first correct rate of 90% and less than the first incorrect answer rate of 90%, the deviation of the exercise performance characteristic values of the practice time period (i.e., the answer time period) corresponding to W+ and W− from the average exercise performance value of all the practice time periods of the user is calculated separately, and if this deviation is greater than the positive deviation threshold, the results with answer “1” are deleted, and if this deviation is less than the negative deviation threshold, the result with answer “0” are deleted.

In this embodiment, after the result is deleted, the exercise category corresponding to the result is no longer obtained when mapping is performed, i.e., the exercise category corresponding to the result is not used for subsequent operations, which reduces unreliable values and deletes values that cannot accurately reflect the user's learning in a similar topic, thereby improving the reliability and accuracy of the prediction results.

A vector construction module 204 for constructing an input vector based on the correspondence set between the exercise categories and the exercise results.

In this embodiment, multiple input vectors can be constructed by selecting several data from the correspondence set.

Specifically, multiple input vectors X={x₁, x₂, x₃, x₄, x₅, . . . , x_{T}} of length T can be constructed by selecting T data multiple times from the correspondence set, where x_{T}={s_{T}, r_{T}}, i.e., x_{T} includes the exercise category s_{T} for the Tth exercise question and exercise result r_{T} for the Tth exercise question.

For instance, the input vector is constructed based on the maximum input length T of the model (i.e., the thinking ability prediction model). If the length of the correspondence set obtained from a single practice session is less than T, it is considered that the user has insufficient practice, and such records are discarded. If the length of the correspondence set exceeds T, it is truncated into multiple input vectors of length T.

Further, in an optional embodiment of the present disclosure, the vector construction module 204 is specifically configured for:

selecting T correspondences from the correspondence set between the exercise categories and the exercise results to construct multiple first vectors of length T, where T is a positive integer;

obtaining answering times and subject study times for each exercise questions from the T correspondences;

adding the answering times and study times respectively to the first vectors to obtain the input vector.

In this embodiment, the subject study time refers to the study time of the subject to which the exercise question belongs. The resulting input vector is an enhanced representation vector.

For example, get T correspondences between the exercise results and the exercise categories of T exercise questions. Then obtain the answer times of the T exercise questions and the study time of the subject to which each exercise question belongs in these T correspondences, and add them to the first vector to obtain the input vector as X={x₁, x₂, x₃, x₄, x₅, . . . , x_{T}}, where x_{T}={s_{T}, r_{T}, m_{T}, n_{T}}, i.e., x_{T}, which includes the exercise category s_{T} for the Tth exercise question, the exercise result r_{T} for the Tth exercise question, the answer time m_{T} for the Tth exercise question, the study time for the Tth exercise question, the study time nr for the subject to which each exercise question belongs.

In this embodiment, by adding answering times and study times to the first vectors, the input vector not only includes practice types and results but also incorporates answering times and study times, allowing for a more accurate prediction of the student's thinking ability.

A second prediction module 205 for inputting the input vector into a thinking ability prediction model to obtain the user's thinking ability prediction result, wherein the thinking ability prediction model includes a fully connected layer, a large language model, a dropout layer, a fully connected layer, and a nonlinear activation layer.

In this embodiment, the obtained thinking ability prediction result is a coefficient of each thinking ability corresponding to the user (including memory, comprehension, application, analysis, and synthesis/creation), e.g., the result of thinking ability is {0.8, 0.8, 0.7, 0.6, 0.5}.

Further, in an optional embodiment of the present disclosure, the large language model can be one of GPT2, T5, or Llama. The apparatus further includes a second model adjustment module. The second model adjustment module is used for:

training the large language model in a manner that self-attention blocks of the large language model is frozen before inputting the input vector into the thinking ability prediction model,.

For example, in the GPT-2 model, the self-attention blocks are located in the first layer of each Transformer block. Thus, the first layer of each Transformer block is frozen during training.

In this embodiment, since the self-attention blocks contain most of the knowledge learned during pre-training, freezing them during fine-tuning protects the performance of the large language model. Meanwhile, the position embeddings and layer normalizations in the large language model are primarily used to enhance downstream tasks. Therefore, these components are retrained to adapt to the thinking ability prediction task.

Further, in an optional embodiment of the present disclosure, the loss function is the cross-entropy loss function.

This training approach of the present embodiment improves training efficiency while ensuring the accuracy of the model obtained from training.

In the present embodiment, the following method is provided: obtaining an exercise text set already completed by a user; inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer; mapping an exercise result set corresponding to the exercise text set to the exercise categories corresponding to each exercise text in the exercise text set, so as to obtain a correspondence set between the exercise categories and the exercise results; constructing an input vector based on the correspondence set between the exercise categories and the exercise results; and inputting the input vector into a thinking ability prediction model to obtain the user's thinking ability prediction result, wherein the thinking ability prediction model includes a fully connected layer, a large language model, a dropout layer, a fully connected layer, and a nonlinear activation layer. The embodiment of the present disclosure does not require evaluation by an expert supervisor, nor do they need to specifically design a particular interview or activity, and the user's thinking ability prediction results can be quickly obtained based on the exercises that the user has participated in, and the evaluation efficiency is highly effective. The purpose of objectively, accurately and conveniently predicting the thinking ability of the learner is realized.

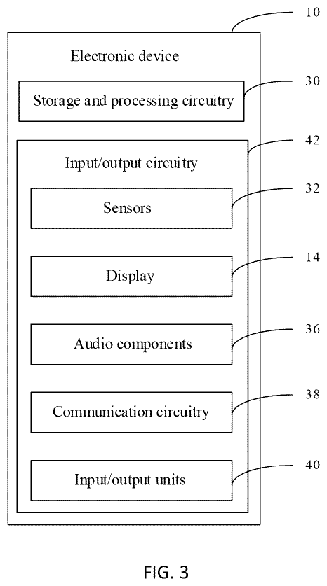

Referring to FIG. 3, a hardware structural schematic diagram of an electronic device according to an embodiment of the present disclosure is shown.

Exemplarily, the electronic device can be a mobile or portable computer system of any kind. Specifically, the electronic device can be a mobile phone, a smartphone (e.g., based on the iPhone™ or Android™ platform), a portable gaming device (e.g., Nintendo DS™, PlayStation Portable™, Gameboy Advance™, iPhone™), a laptop, a personal digital assistant (PDA), a portable internet device, or other handheld devices, as well as electronic devices such as watches, headphones, pendants, earpieces, etc. The electronic device can also be other wearable devices (e.g., head-mounted displays (HMDs), electronic clothing, electronic bracelets, electronic necklaces, smartwatches, etc.).

The electronic device can also be any of multiple electronic devices, which include but are not limited to cellular telephones, smartphones, other wireless communication devices, personal digital assistants, audio players, media players, music recorders, video recorders, cameras, radio receivers, medical devices, vehicle transport instruments, calculators, programmable remote controls, pagers, laptop computers, desktop computers, printers, netbook computers, personal digital assistants (PDAs), portable multimedia players (PMPs), Moving Picture Experts Group (MPEG-1 or MPEG-2) Audio Layer 3 (MP3) players, portable medical devices, and digital cameras, among others, as well as combinations thereof.

In some cases, the electronic device can perform multiple functions (e.g., play music, display video, store images, and receive and make voice over internet protocol (VOIP) telephone calls). If necessary, the electronic device can be a portable device such as a cellular telephone, media player, other handheld device, wristwatch device, pendant device, headset device, or other compact portable device.

As shown in FIG. 3, the electronic device 10 can include control circuitry, which can include storage and processing circuitry 30. The storage and processing circuitry 30 can include storage device, such as hard disk drive storage, non-volatile memory (e.g., flash memory or other electronically programmable read-only memory used to form solid-state drives, etc.), volatile memory (e.g., static or dynamic random-access memory, etc.), among others, with no limitation in the present disclosure. The processing circuitry within the storage and processing circuitry 30 can be used to control the operation of the electronic device 10. The processing circuitry can be implemented based on one or more microprocessors, microcontrollers, digital signal processors, baseband processors, power management units, audio codecs, application-specific integrated circuits, display driver integrated circuits, etc.

The storage and processing circuitry 30 can be used to run software on the electronic device 10, such as internet browsing applications, voice over internet protocol (VOIP) telephone call applications, email applications, media playback applications, operating system functions, etc. These software applications can be used to perform various control operations, such as image capture based on a camera, environmental light measurement based on an ambient light sensor, proximity measurement based on a proximity sensor, information display functions using status indicators such as light-emitting diodes, touch event detection based on touch sensors, functions related to displaying information on multiple (e.g., hierarchical) displays, operations associated with wireless communication functions, operations related to audio signal collection and processing, control operations associated with button press event data collection, and other functions of the electronic device 10, with no limitation in the present disclosure.

Further, the memory stores executable program code. The processor, coupled to the memory, calls the executable program code stored in the memory to perform the deep learning-based thinking ability prediction method described in the embodiment shown in FIG. 1.

The executable program code includes the modules of the deep learning-based thinking ability prediction apparatus described in the embodiment shown in FIG. 2, such as the obtaining module, first prediction module, mapping module, vector construction module, and second prediction module.

Further, the electronic device 10 can include input/output circuitry 42. The input/output circuitry 42 can be used to enable data input and output for the electronic device 10, that is, allowing the electronic device 10 to receive data from external devices and also to output data from the electronic device 10 to external devices. The input/output circuitry 42 can further include sensors 32. The sensors 32 can include ambient light sensors, optical and capacitive proximity sensors, touch sensors (e.g., touch sensor arrays formed by transparent touch sensor electrodes such as indium tin oxide (ITO) electrodes, or touch sensors formed using other touch technologies such as acoustic touch, pressure-sensitive touch, resistive touch, or optical touch, which can be part of a touchscreen display or used as an independent touch sensor structure), accelerometers, and other sensors.

The input/output circuitry 42 can also include one or more displays, such as display 14. The display 14 can include liquid crystal displays, organic light-emitting diode displays, electronic ink displays, plasma displays, and other display technologies, either individually or in combination. The display 14 can include a touch sensor array (i.e., can be a touchscreen display). The touch sensors can be formed by capacitive touch sensor arrays using transparent electrodes (e.g., indium tin oxide (ITO) electrodes) or can be touch sensors formed using other touch technologies such as acoustic touch, pressure-sensitive touch, resistive touch, optical touch, etc.

The electronic device 10 can also include audio components 36. The audio components 36 can be used to provide audio input and output functions for the electronic device 10. The audio components 36 of the electronic device 10 can include speakers, microphones, buzzers, tone generators, and other components for producing and detecting sound.

The communication circuitry 38 can be used to provide the electronic device 10 with the capability to communicate with external devices. The communication circuitry 38 can include analog and digital input/output interface circuits, as well as wireless communication circuits based on radio frequency signals and/or optical signals. The wireless communication circuits in the communication circuitry 38 can include radio frequency transceiver circuits, power amplifier circuits, low-noise amplifier circuits, switches, filters, and antennas. For example, the communication circuitry 38 can include circuits for near-field communication (NFC) that support data transmission and reception via near-field coupled electromagnetic signals. For instance, the communication circuitry 38 can include NFC antennas and NFC transceivers. The communication circuitry 38 can also include cellular telephone transceivers and antennas, wireless local area network transceiver circuits and antennas, etc.

The electronic device 10 can further include a battery, power management circuits, and other input/output units 40. The input/output units 40 can include buttons, joysticks, click wheels, scroll wheels, touchpads, keypads, keyboards, cameras, light-emitting diodes, and other status indicators.

Users can input commands through the input/output circuitry 42 to control the operation of the electronic device 10 and can also use the input/output circuitry 42 to receive status information and other outputs from the electronic device 10.

Further, the present disclosure also provides a computer-readable storage medium. The computer-readable storage medium can be located in the electronic devices described in the above embodiments and can be the memory within the storage and processing circuitry 30. The computer-readable storage medium stores a computer program. When the computer program is executed by a processor, it implements the deep learning-based method for predicting thinking ability described in the above embodiments. Additionally, the computer-readable storage medium can also be a USB flash drive, a mobile hard disk, a read-only memory (ROM), a RAM, a magnetic disk, an optical disc, or any other medium capable of storing program code.

It should be noted that, for the sake of simplicity, the foregoing method embodiments are described as a series of action combinations. However, those skilled in the art should understand that the present invention is not limited by the described sequence of actions, as certain steps may be performed in a different order or simultaneously in accordance with the present invention. Furthermore, those skilled in the art should also recognize that the embodiments described in the specification are preferred examples, and the involved actions and modules are not necessarily mandatory for the present invention.

In the above embodiments, the description of each embodiment emphasizes different aspects. For parts not detailed in a particular embodiment, reference may be made to the relevant descriptions in other embodiments.

The foregoing describes the deep learning-based cognitive ability prediction method, apparatus, and computer-readable storage medium provided by the present invention. Based on the concepts of the embodiments of the present invention, those of ordinary skill in the art may make modifications to specific implementations and application scopes. Therefore, the content of this specification should not be construed as limiting the invention.

What is claimed is:

1. A deep learning-based method for predicting thinking ability, comprising:
obtaining an exercise text set already completed by a user;
inputting the exercise text set into an exercise classification model to obtain corresponding exercise categories for each exercise text in the exercise text set, wherein the exercise classification model comprises a pre-trained text classification model, a dropout layer, a fully connected layer, and a nonlinear activation layer;
mapping an exercise result set corresponding to the exercise text set to the exercise categories corresponding to each exercise text in the exercise text set, so as to obtain a correspondence set between the exercise categories and the exercise results;
constructing an input vector based on the correspondence set between the exercise categories and the exercise results; and
inputting the input vector into a thinking ability prediction model to obtain the user's thinking ability prediction result, wherein the thinking ability prediction model comprises a fully connected layer, a large language model, a dropout layer, a fully connected layer, and a nonlinear activation layer.

2. The method according to claim 1, wherein the large language model is one of GPT2, T5, or Llama; before inputting the input vector into the thinking ability prediction model, the method further comprises:
training the large language model in a manner that self-attention blocks of the large language model is frozen.

3. The method according to claim 1, wherein before inputting the exercise text set into the exercise classification model, the method further comprises:
fine-tuning the exercise classification model using training data and a loss function, the loss function being a Focal loss.

4. The method according to claim 1, wherein constructing an input vector based on the correspondence set between the exercise categories and the exercise results comprises:
selecting T correspondences from the correspondence set between the exercise categories and the exercise results to construct multiple first vectors of length T, T being a positive integer;
obtaining answering times and subject study times for each exercise questions from the T correspondences; and
adding the answering times and study times respectively to the first vectors to obtain the input vector.

5. The method according to claim 1, wherein before mapping an exercise result set corresponding to the exercise text set to the exercise categories corresponding to each exercise text in the exercise text set, the method further comprises:
obtaining a similar exercise text subset from the exercise text set, where the similarity between exercise texts in the similar exercise text subset meets a similarity condition;
obtaining a similar exercise result subset corresponding to the similar exercise text subset from the exercise result set corresponding to the exercise text set;
when values in the similar exercise results subset are different, obtaining a correct answer rate or an incorrect answer rate of exercise knowledge points corresponding to the similar exercise text subset;
when the correct answer rate exceeds a first accuracy threshold, removing results marked as incorrect in the exercise result set corresponding to the similar exercise result subset;
when the incorrect answer rate exceeds a first error threshold, removing results marked as correct in the exercise result set corresponding to the similar exercise result subset;
when the correct answer rate is less than the first accuracy threshold and the incorrect answer rate is less than the first error threshold, calculating deviations between exercise performance characteristic values for each similar exercise text of the similar exercise text subset during the corresponding practice time periods and an average exercise performance value; and
when the deviation exceeds a positive deviation threshold, removing results marked as correct in the exercise result set corresponding to the similar exercise result subset.

6. The method according to claim 1, wherein after obtaining an exercise text set already completed by a user, the method further comprises:
obtaining text data exercised by the user within a preset time period and the user's age;
calculating the total volume of the obtained text data; and
deleting or retaining the obtained text data based on the total volume and the user's age, and further determining the retained text date to form the exercise text set.

7. The method according to claim 6, wherein deleting or retaining the obtained text data based on the total volume and the user's age, and further determining the retained text date to form the exercise text set comprises:
calculating a first data volume of a text data originating from in-class sources of the total data volume and a second data volume of a text data originating from out-of-class sources of the total data volume based on a text source of the text data; and
deleting or retaining the obtained text data based on the first data volume, the second data volume, and the user's age, and further determining the retained text date to form the exercise text set.

8. A deep learning-based apparatus for predicting thinking ability comprising:
an obtaining module configured for obtaining an exercise text set already completed by a user;
a first prediction module configured for inputting the exercise text set into an exercise classification model to obtain corresponding exercise categories for each exercise text in the exercise text set, wherein the exercise classification model includes a pre-trained text classification model, a dropout layer, a fully connected layer, and a nonlinear activation layer;
a mapping module configured for mapping an exercise result set corresponding to the exercise text set to the exercise categories corresponding to each exercise text in the exercise text set, so as to obtain a correspondence set between the exercise categories and the exercise results;
a vector construction module configured for constructing an input vector based on the correspondence set between the exercise categories and the exercise results; and
a second prediction module configured for inputting the input vector into a thinking ability prediction model to obtain the user's thinking ability prediction result, wherein the thinking ability prediction model includes a fully connected layer, a large language model, a dropout layer, a fully connected layer, and a nonlinear activation layer.

9. The apparatus according to claim 8, wherein the large language model is one of GPT2, T5, or Llama; the apparatus further comprises second model adjustment module is configured for:
training the large language model in a manner that self-attention blocks of the large language model is frozen before inputting the input vector into the thinking ability prediction model.

10. The apparatus according to claim 8 further comprising a first model adjustment module configured for:
fine-tuning the exercise classification model using training data and a loss function before inputting the exercise text set into the exercise classification model, wherein the loss function is a Focal loss.

11. The apparatus according to claim 8, wherein the vector construction module is specifically configured for:
selecting T correspondences from the correspondence set between the exercise categories and the exercise results to construct multiple first vectors of length T, where T is a positive integer;
obtaining answering times and subject study times for each exercise questions from the T correspondences;
adding the answering times and study times respectively to the first vectors to obtain the input vector.

12. The apparatus according to claim 8 further comprising a second adjustment module configured for:
before mapping an exercise result set corresponding to the exercise text set to the exercise categories corresponding to each exercise text in the exercise text set, obtaining a similar exercise text subset from the exercise text set, where the similarity between exercise texts in the similar exercise text subset meets a similarity condition;
obtaining a similar exercise result subset corresponding to the similar exercise text subset from the exercise result set corresponding to the exercise text set;
when values in the similar exercise results subset are different, obtaining a correct answer rate or an incorrect answer rate of exercise knowledge points corresponding to the similar exercise text subset;
when the correct answer rate exceeds a first accuracy threshold, removing results marked as incorrect in the exercise result set corresponding to the similar exercise result subset;
when the incorrect answer rate exceeds a first error threshold, removing results marked as correct in the exercise result set corresponding to the similar exercise result subset;
when the correct answer rate is less than the first accuracy threshold and the incorrect answer rate is less than the first error threshold, calculating deviations between exercise performance characteristic values for each similar exercise text of the similar exercise text subset during the corresponding practice time periods and an average exercise performance value; and
when the deviation exceeds a positive deviation threshold, removing results marked as correct in the exercise result set corresponding to the similar exercise result subset.

13. The apparatus according to claim 8 further comprising a first adjustment module configured for:
obtaining text data exercised by the user within a preset time period and the user's age after obtaining the exercise text set already completed by the user;
calculating the total volume of the obtained text data;
deleting or retaining the obtained text data based on the total volume and the user's age, and further determining the retained text date to form the exercise text set.

14. The apparatus according to claim 13, wherein the first adjustment module is further configured for:
calculating a first data volume of a text data originating from in-class sources of the total data volume and a second data volume of a text data originating from out-of-class sources of the total data volume based on a text source of the text data; and
deleting or retaining the obtained text data based on the first data volume, the second data volume, and the user's age, and further determining the retained text date to form the exercise text set.

15. A electronic device comprising:
a storage device, storing executable program code;
a processor, coupled to the storage device, wherein the processor calls the executable program code stored in the storage device to execute the deep learning-based method for predicting thinking ability according to claim 1.

16. The device according to claim 15, wherein after obtaining an exercise text set already completed by a user, the device further:
obtaining text data exercised by the user within a preset time period and the user's age;
calculating the total volume of the obtained text data; and
deleting or retaining the obtained text data based on the total volume and the user's age, and further determining the retained text date to form the exercise text set.

17. The device according to claim 16, wherein deleting or retaining the obtained text data based on the total volume and the user's age, and further determining the retained text date to form the exercise text set comprises:
calculating a first data volume of a text data originating from in-class sources of the total data volume and a second data volume of a text data originating from out-of-class sources of the total data volume based on a text source of the text data; and
deleting or retaining the obtained text data based on the first data volume, the second data volume, and the user's age, and further determining the retained text date to form the exercise text set.

18. A non-transitory computer-readable storage medium storing a computer program, wherein when the computer program is executed by a processor, it implements the deep learning-based method for predicting thinking ability according to claim 1.

19. The storage medium according to claim 18, wherein after obtaining an exercise text set already completed by a user, the storage medium further:
obtaining text data exercised by the user within a preset time period and the user's age;
calculating the total volume of the obtained text data; and
deleting or retaining the obtained text data based on the total volume and the user's age, and further determining the retained text date to form the exercise text set.

20. The storage medium according to claim 19, wherein deleting or retaining the obtained text data based on the total volume and the user's age, and further determining the retained text date to form the exercise text set comprises:
calculating a first data volume of a text data originating from in-class sources of the total data volume and a second data volume of a text data originating from out-of-class sources of the total data volume based on a text source of the text data; and
deleting or retaining the obtained text data based on the first data volume, the second data volume, and the user's age, and further determining the retained text date to form the exercise text set.
